(19) United States
(12) Patent Application Publication
(10) Pub. No.: US 2015/0318936 A1
(43) Pub. Date: Nov. 5, 2015

(54) BURSTY-INTERFERENCE-AWARE INTERFERENCE MANAGEMENT UTILIZING CONDITIONAL METRIC

(71) Applicant: QUALCOMM Incorporated, San Diego, CA (US)

(72) Inventors: Nachiappan VALLIAPPAN, San Diego, CA (US); Kambiz AZARIAN YAZDI, San Diego, CA (US)

(73) Assignee: QUALCOMM Incorporated, San Diego, CA (US)

(21) Appl. No.: 14/268,343

(22) Filed: May 2, 2014

(51) Int. Cl. H04B 17/345; H04W 72/08; H04W 24/02; H04B 17/318

(52) U.S. Cl. CPC H04B 17/345; H04B 17/318; H04W 72/082; H04W 24/02

(57) ABSTRACT

Interference management for a wireless device in a wireless communication system may operate by, for example, determining a loss pattern from one or more block acknowledgement (ACK) bitmaps. The loss pattern may comprise a plurality of values indicating reception success or reception failure of a corresponding media access control (MAC) protocol data unit (MPDU) at a receiving station. A conditional MPDU error rate metric may be computed correlating the loss pattern values over a time window of interest. The conditional MPDU error rate metric may be compared to a corresponding bursty interference signature associated with a time-independence among the loss pattern values that is characteristic of bursty interference. Based on the comparison, a bursty interference condition may be identified, and a bursty interference indicator may be generated based on the identification of the bursty interference condition.

### REFERENCE TO CO-PENDING APPLICATIONS FOR PATENT

The present application for patent is related to the following co-pending U.S. patent application:
“BURSTY-INTERFERENCE-AWARE INTERFERENCE MANAGEMENT UTILIZING RUN-LENGTHS,” having Attorney Docket No. QC134688U2, filed concurrently herewith, assigned to the assignee hereof, and expressly incorporated herein by reference in its entirety.

### INTRODUCTION

Aspects of this disclosure relate generally to telecommunications, and more particularly to interference management and the like.

Wireless communication systems are widely deployed to provide various types of communication content, such as voice, data, and so on. Typical wireless communication systems are multiple-access systems capable of supporting communication with multiple users by sharing available system resources (e.g., bandwidth, transmit power, etc.). One class of such multiple-access systems is generally referred to as “Wi-Fi,” and includes different members of the Institute of Electrical and Electronics Engineers (IEEE) 802.11 wireless protocol family. Generally, a Wi-Fi communication system can simultaneously support communication for multiple wireless stations (STAs). Each STA communicates with one or more access points (APs) via transmissions on the downlink and the uplink. The downlink (DL) refers to the communication link from the APs to the STAs, and the uplink (UL) refers to the communication link from the STAs to the APs.

Various protocols and procedures in Wi-Fi, such as carrier sense multiple access (CSMA), allow different STAs operating on the same channel to share the same wireless medium. However, because of hidden terminals, for example, Wi-Fi STAs operating in neighboring basic service sets (BSSs) on the same channel may still interfere with one another. This interference degrades the performance of the wireless link because of increased packet losses. Packet losses in dense Wi-Fi deployments may be broadly classified into three types: packet losses due to channel fading; packet collisions due to long, data packet transmissions (usually DL transmissions from other co-channel APs and/or STAs); and packet collisions due to short, bursty (time-selective) packet transmissions (usually acknowledgement, management, and upper layer packets from other co-channel APs and/or STAs). Conventional rate control algorithms are not designed to handle bursty interference.

There accordingly remains a need for classifying the type of packet errors/interference observed according to the nature of the interferer and channel conditions, and for taking remedial actions appropriate to the type of packet errors/interference determined to be present.

### SUMMARY

Systems and methods for interference management for a wireless device in a wireless communication system are disclosed.

A method of interference management for a wireless device in a wireless communication system is disclosed. The method may comprise, for example: determining a loss pattern from one or more block acknowledgement (ACK) bitmaps, the loss pattern comprising a plurality of values indicating reception success or reception failure of a corresponding media access control (MAC) protocol data unit (MPDU) at a receiving station; computing a conditional MPDU error rate metric correlating the loss pattern values over a time window of interest; comparing the conditional MPDU error rate metric to a corresponding bursty interference signature associated with a time-independence among the loss pattern values that is characteristic of bursty interference; identifying a bursty interference condition based on the comparison; and generating a bursty interference indicator based on the identification of the bursty interference condition.

An apparatus for interference management for a wireless device in a wireless communication system is also disclosed. The apparatus may comprise, for example, a processor and memory coupled to the processor for storing related data and instructions. The processor may be configured to, for example: determine a loss pattern from one or more block ACK bitmaps, the loss pattern comprising a plurality of values indicating reception success or reception failure of a corresponding MPDU at a receiving station; compute a conditional MPDU error rate metric correlating the loss pattern values over a time window of interest; compare the conditional MPDU error rate metric to a corresponding bursty interference signature associated with a time-independence among the loss pattern values that is characteristic of bursty interference; identify a bursty interference condition based on the comparison; and generate a bursty interference indicator based on the identification of the bursty interference condition.

Another apparatus for interference management for a wireless device in a wireless communication system is also disclosed. The apparatus may comprise, for example: means for determining a loss pattern from one or more block ACK bitmaps, the loss pattern comprising a plurality of values indicating reception success or reception failure of a corresponding MPDU at a receiving station; means for computing a conditional MPDU error rate metric correlating the loss pattern values over a time window of interest; means for comparing the conditional MPDU error rate metric to a corresponding bursty interference signature associated with a time-independence among the loss pattern values that is characteristic of bursty interference; means for identifying a bursty interference condition based on the comparison; and means for generating a bursty interference indicator based on the identification of the bursty interference condition.

A computer-readable medium comprising code, which, when executed by a processor, causes the processor to perform operations for interference management for a wireless device in a wireless communication system is also disclosed. The computer-readable medium may comprise, for example: code for determining a loss pattern from one or more block ACK bitmaps, the loss pattern comprising a plurality of values indicating reception success or reception failure of a corresponding MPDU at a receiving station; code for computing a conditional MPDU error rate metric correlating the loss pattern values over a time window of interest; code for comparing the conditional MPDU error rate metric to a corresponding bursty interference signature associated with a time-independence among the loss pattern values that is characteristic of bursty interference; code for identifying a bursty interference condition based on the comparison; and code for generating a bursty interference indicator based on the identification of the bursty interference condition.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless network.

FIG. 2 illustrates example classes of interference that may be experienced by nodes in a wireless network.

FIG. 3 illustrates the effect of bursty interference during an example transmission opportunity.

FIG. 4 is a block diagram illustrating an example bursty-interference-aware interference management module for a wireless device in a wireless communication system.

FIG. 5 is a block diagram illustrating an example design for one or more bursty interference detection aspects of a bursty-interference-aware interference management module.

FIG. 6 is an example probability distribution that is characteristic of channel fading without bursty interference.

FIG. 7 is an example probability distribution that is characteristic of the presence of a bursty interferer.

FIG. 8 is a block diagram illustrating an example design for one or more bursty interference control aspects of a bursty-interference-aware interference management module.

FIG. 9 is a block diagram illustrating another example design for one or more bursty interference control aspects of a bursty-interference-aware interference management module.

FIG. 10 is a flow diagram illustrating an example method of interference management for a wireless device in a wireless communication system.

FIG. 11 is a simplified block diagram of several sample aspects of components that may be employed in communication nodes.

FIG. 12 is a simplified block diagram of several sample aspects of communication components.

FIG. 13 is a simplified block diagram of several sample aspects of apparatuses configured to support communication as taught herein.

### DETAILED DESCRIPTION

The disclosure relates in some aspects to interference management for a wireless device in a wireless communication system. By comparing a conditional error rate metric correlating reception errors over time to a corresponding bursty interference signature, a bursty interference condition may be identified on a communication channel. The error rate metric and the bursty interference signature may correspond to probability distributions, for example, and facilitate identification of characteristic bursty interference behavior among reception errors. By providing bursty-interference-aware interference management, the present disclosure enables more sophisticated rate control to increase user throughputs and enhance overall network capacity.

Aspects of the disclosure are provided in the following description and related drawings directed to specific disclosed aspects. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

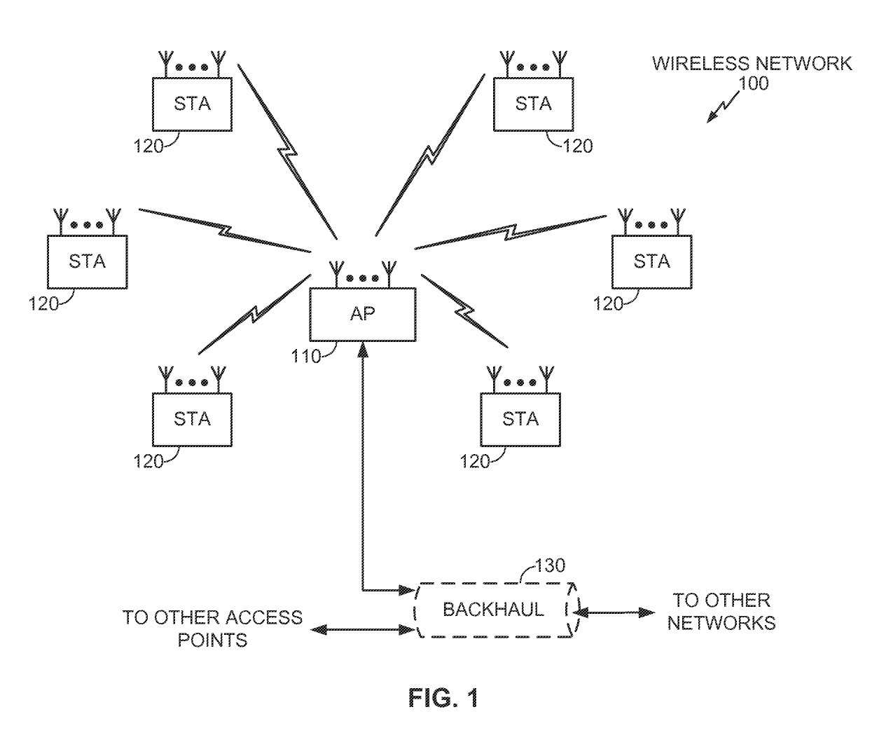

FIG. 1 illustrates an example wireless network 100. As shown, the wireless network 100, which may also be referred to herein as a basic service set (BSS), is formed from several wireless nodes, including an access point (AP) 110 and a plurality of subscriber stations (STAs) 120. Each wireless node is generally capable of receiving and/or transmitting. The wireless network 100 may support any number of APs 110 distributed throughout a geographic region to provide coverage for the STAs 120. For simplicity, one AP 110 is shown in FIG. 1, providing coordination and control among the STAs 120, as well as access to other APs or other networks (e.g., the Internet) via a backhaul connection 130.

The AP 110 is generally a fixed entity that provides backhaul services to the STAs 120 in its geographic region of coverage. However, the AP 110 may be mobile in some applications (e.g., a mobile device serving as a wireless hotspot for other devices). The STAs 120 may be fixed or mobile. Examples of STAs 120 include a telephone (e.g., cellular telephone), a laptop computer, a desktop computer, a personal digital assistant (PDA), a digital audio player (e.g., MP3 player), a camera, a game console, a display device, or any other suitable wireless node. The wireless network 100 may be referred to as a wireless local area network (WLAN), and may employ a variety of widely used networking protocols to interconnect nearby devices. In general, these networking protocols may be referred to as “Wi-Fi,” including any member of the Institute of Electrical and Electronics Engineers (IEEE) 802.11 wireless protocol family.

For various reasons, interference may exist in the wireless network 100, leading to different degrees of packet loss and degradations of performance. The interference may be derived from different sources, however, and different classes of interference may affect the wireless network 100 in different ways. Several example classes of interference are described below.

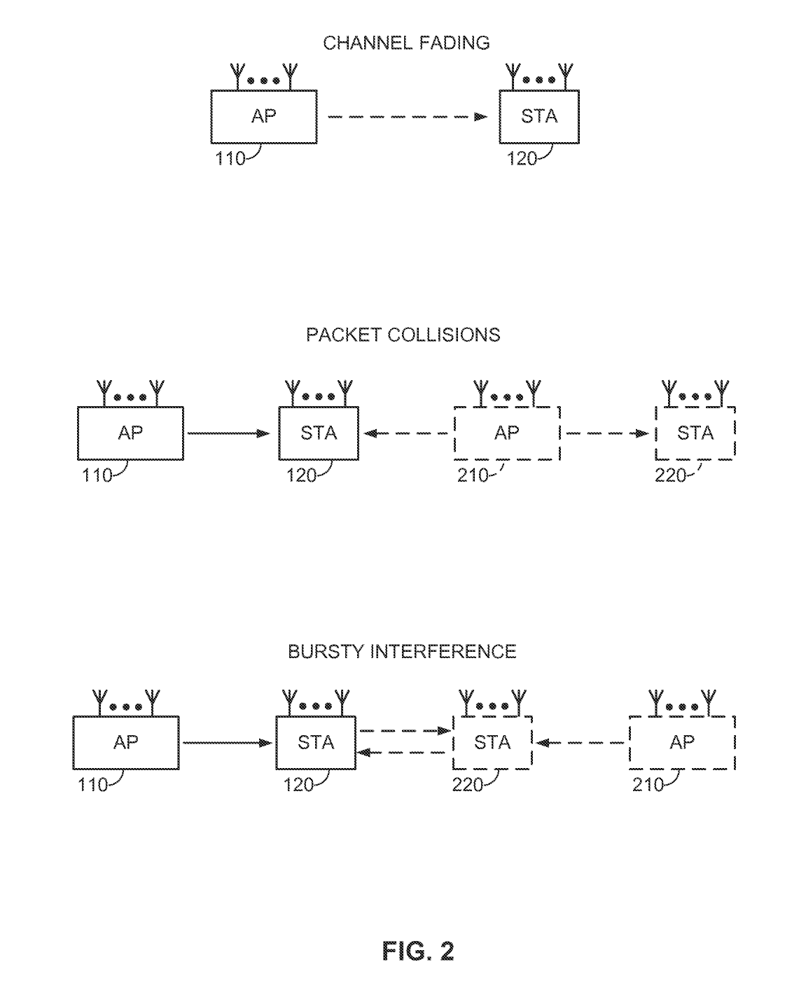

FIG. 2 illustrates several example classes of interference that may be experienced by nodes in a wireless network. In each of the examples, the AP 110 and one of the STAs 120 of the wireless network 100 from FIG. 1 are engaged in a downlink communication session where the AP 110 sends one or more packets to the STA 120.

In the first illustrated interference scenario, the communication link between the AP 110 and the STA 120 experiences time-varying signal conditions due to environmental variations, such as multipath propagation effects or shadowing. This interference scenario is typically referred to as channel fading.

In the second illustrated interference scenario, the STA 120 is operating in the vicinity of another BSS including a neighboring AP 210 and a neighboring STA 220. Because the STA 120 is within range of the neighboring AP 210, co-channel transmissions from the neighboring AP 210 to the neighboring STA 220 will be received at the STA 120 as well, thereby distorting channel conditions and interfering with the communication link between the AP 110 and the STA 120. This interference scenario is typically referred to as (long) packet collisions.

In the third illustrated interference scenario, the STA 120 is again operating in the vicinity of another BSS including the neighboring AP 210 and the neighboring STA 220. Here, the STA 120 is out of range of the neighboring AP 210 but within range of the neighboring STA 220. Because the STA 120 is within range of the neighboring STA 220, any transmissions from the neighboring STA 220 to the neighboring AP 210 may potentially interfere with the communication link between the AP 110 and the STA 120. (The same is true of transmissions from the STA 120 to the AP 110, which may potentially interfere with the communication link between the neighboring AP 210 and the neighboring STA 220, as shown.) Examples of potentially interfering communications include not only uplink data traffic, but also acknowledgement (ACK) messages, management messages, and various other upper layer signaling. This interference scenario is typically referred to as (short) bursty interference, and derives from the “hidden node” or “hidden terminal” problem.

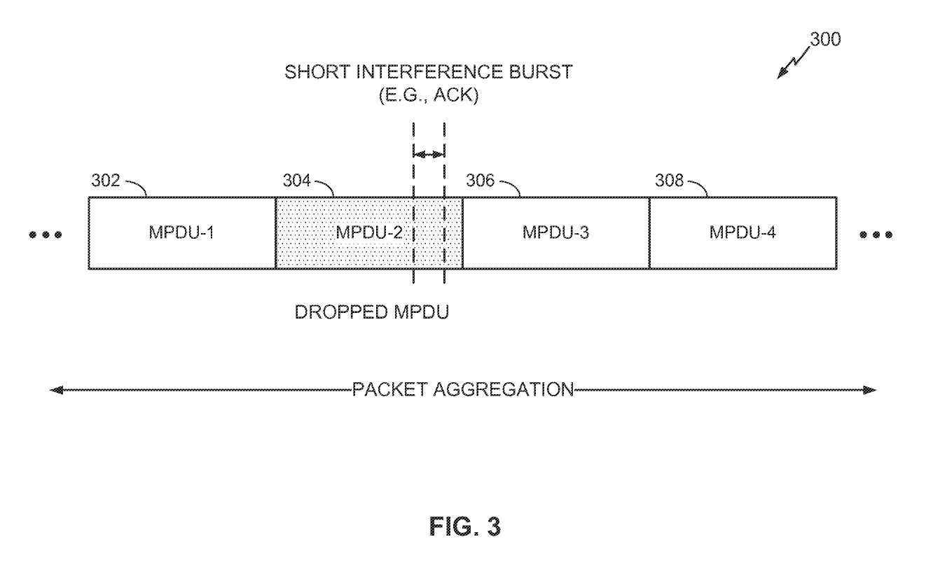

FIG. 3 illustrates the effect of bursty interference during an example transmission opportunity (TxOP). In this example, the transmission 300 includes an aggregation of media access control (MAC) protocol data units (MPDUs), including a first MPDU (MPDU-1) 302, a second MPDU (MPDU-2) 304, a third MPDU (MPDU-3) 306, and a fourth MPDU (MPDU-4) 308. An MPDU is a message subframe exchanged between MAC entities, such as the AP 110 and one of the STAs 120 of the wireless network 100 shown in FIG. 1. When the MPDU is larger than the MAC service data unit (MSDU) received from a higher layer in the protocol stack, the MPDU may include multiple MSDUs as a result of packet aggregation. When the MPDU is smaller than the MSDU, each MSDU may generate multiple MPDUs as a result of packet segmentation.

As shown, the second MPDU (MPDU-2) 304 is subjected to a short burst of interference, such as an ACK message from a neighboring node as discussed above in relation to FIG. 2. The interference bursts causes the decoding of the second MPDU (MPDU-2) 304 to fail, and for the second MPDU (MPDU-2) 304 to be dropped.

As discussed in the background above, conventional rate control algorithms are designed to handle channel fading and packet collision interference scenarios, not bursty interference scenarios such as the one illustrated in FIG. 3. In fact, conventional rate control algorithms applied to bursty interference may actually exacerbate the effect of the interference. For example, reducing the transmission rate in response to the dropped MPDU (e.g., via a lower modulation and coding scheme), as appropriate for a packet collision interference scenario, decreases the number of MPDUs transmitted during a given TxOP and therefore increases the relative impact of a short interference burst. By providing bursty-interference-aware interference management, the present disclosure enables more sophisticated rate control to increase user throughputs and enhance overall network capacity.

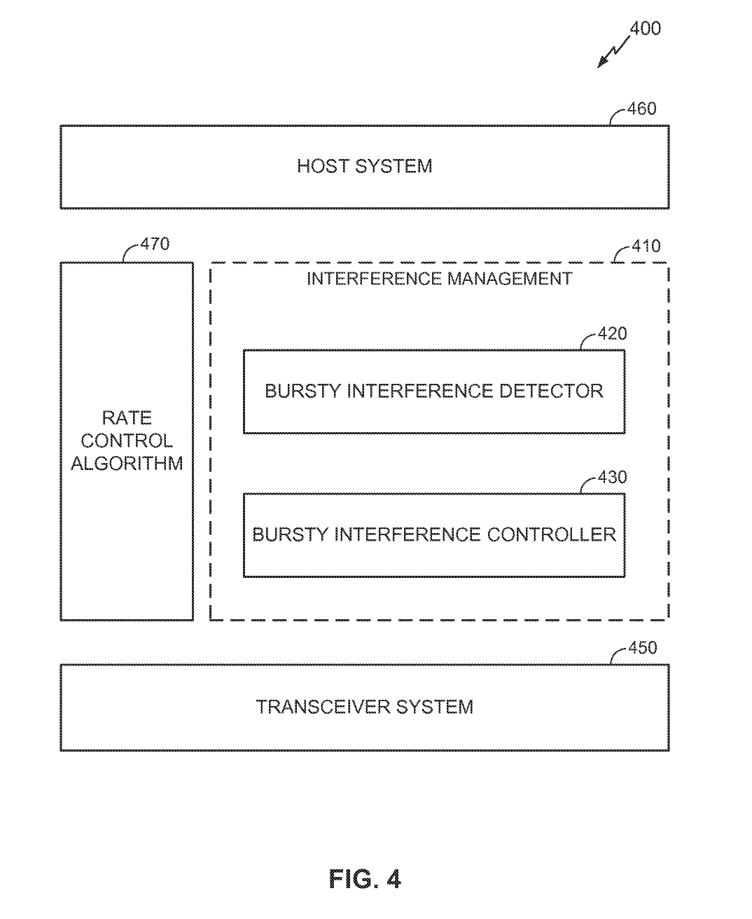

FIG. 4 is a block diagram illustrating an example bursty-interference-aware interference management module for a wireless device in a wireless communication system. The wireless device 400 in which the interference management module 410 is deployed may be a Wi-Fi access point, for example, such as the AP 110 in FIG. 1, but more generally any entity performing or assisting with rate control (e.g., one of the STAs 120 in FIG. 1). In other examples, the illustrated components may be spread out over multiple entities (e.g., one of the STAs 120 in FIG. 1 may perform some of the processing operations itself before sending the results thereof to the AP 110 for rate control purposes).

As shown, the interference management module 410 may be deployed in conjunction with native transceiver system functionality 450 and host system functionality 460 of the wireless device 400. The transceiver system 450 provides the requisite wireless communication functionality in accordance with a given communication protocol (e.g., Wi-Fi), and may include one or more antennas, modulators, demodulators, buffers, TX/RX processors, and so on. Among other tasks, the transceiver system 450 in this example configuration performs packet (e.g., MPDU) processing and associated functions. The host system 460 provides the application-oriented services for the wireless device 400, and may include a processor, associated memory, software for a variety of applications, special purpose modules, and so on.

The interference management module 410 may also be deployed in conjunction with a rate control algorithm 470 operating at the wireless device 400. Rate control algorithms are employed by wireless devices to control the transmission data rate by optimizing system performance. They may operate, for example, based on throughput calculations and drop probabilities associated with different rates (e.g., a table that is dynamically populated or derived from predetermined simulations). If the current throughput is less than the drop probability, for example, the rate control algorithm may increase the transmission data rate.

Turning to the interference management module 410 in more detail, the interference management module 410 may include a bursty interference detector 420 and a bursty interference controller 430. The bursty interference detector 420 is configured to identify a bursty interference condition on a communication channel, as distinguished from channel fading interference and packet collisions. In response to the identification, the bursty interference controller 430 is configured to take remedial action to address the bursty interference condition. The bursty interference detector 420 and the bursty interference controller 430 may be implemented in different ways according to different designs and applications. Several examples are provided below.

It will be appreciated that although the disclosed examples may be discussed individually for illustration purposes, different aspects of the different implementations for the bursty interference detector 420 and/or the bursty interference controller 430 may be combined in different ways, not only with other disclosed aspects but also with other aspects beyond the scope of this disclosure, as appropriate. Conversely, it will be appreciated that different aspects of the different implementations for the bursty interference detector 420 and/or the bursty interference controller 430 may be used independently, even if described in concert for illustration purposes.

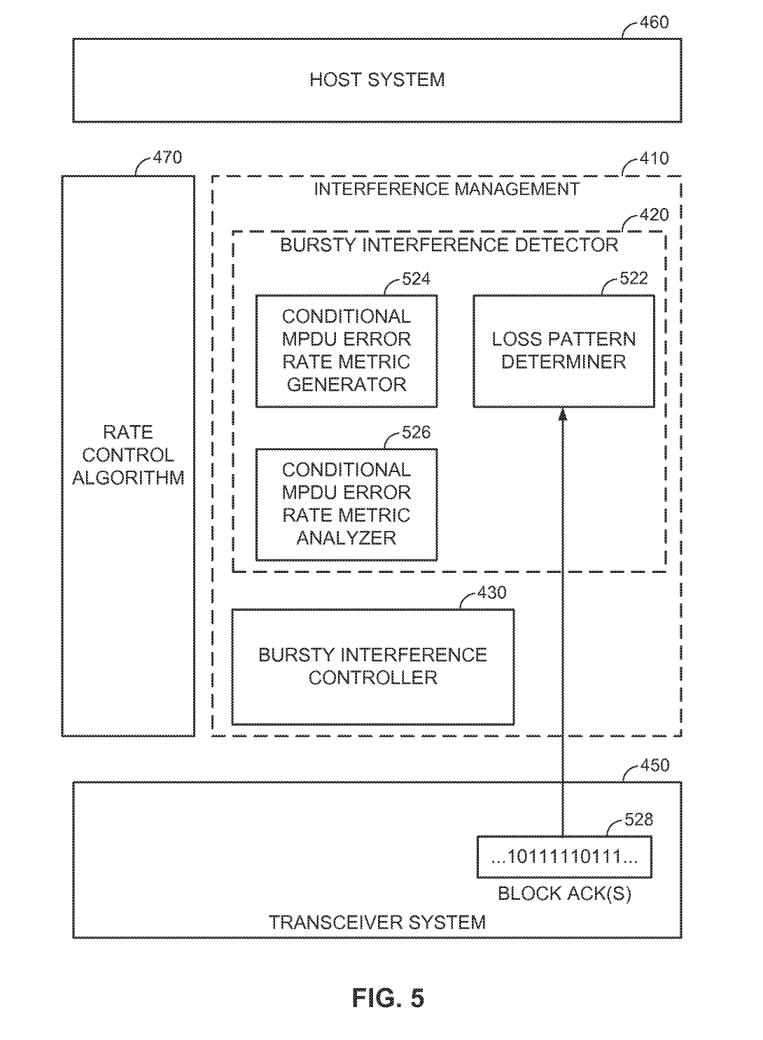

FIG. 5 is a block diagram illustrating an example design for one or more bursty interference detection aspects of a bursty-interference-aware interference management module. In this example, the bursty interference detector 420 includes a loss pattern determiner 522, a conditional MPDU error rate metric generator 524, and a conditional MPDU error rate metric analyzer 526.

The loss pattern determiner 522 is configured to determine a loss pattern from one or more block ACK bitmaps 528. In Wi-Fi, for example, instead of transmitting an individual ACK message for every MPDU, multiple MPDUs can be acknowledged together using a single “block ACK” frame. Each bit of the block ACK bitmap represents the status (success/failure) of a corresponding MPDU. In the illustrated example, the loss pattern determiner 522 receives a block ACK 528 via the transceiver system 450, either indirectly (e.g., the transceiver system 450 being part of the AP 110 in FIG. 1 and receiving information from one of the STAs 120) or directly (e.g., the transceiver system 450 being part of one of the STAs 120 in FIG. 1 and generating the block ACK information itself). This type of channel information can be leveraged by the loss pattern determiner 522 to create a loss pattern comprising a plurality of values indicating reception success or reception failure of a corresponding MPDU at a receiving station (e.g., one of the STAs 120). Information from multiple block ACKs may be aggregated as required over a time window of interest (e.g., a short time window on the order of 80-100 ms), which may be a sliding window to allow for repeated (e.g., continuous or periodic) analysis of channel conditions.

In some designs, the loss pattern determiner 522 may perform certain pre-processing operations to clean up the block ACK bitmaps for creating the loss pattern. For example, the loss pattern determiner 522 may pre-process the one or more block ACK bitmaps to remove any ACK bits corresponding to MPDUs that were not re-transmitted (e.g., by the AP 110 in FIG. 1 to one of the STAs 120) but are still being acknowledged as part of the retransmission procedure (e.g., for sequencing control purposes). The deleted bits correspond to MPDUs that were successfully decoded in the first round of transmission, and hence, are already represented in a preceding block ACK. In this way, the loss pattern may be considered to represent the “true-bitmap,” without the typical redundancies introduced by simply merging raw block ACK data.

The conditional MPDU error rate metric generator 524 is configured to compute a conditional MPDU error rate metric correlating the loss pattern values over time. For example, given that a reception failure has occurred at one MPDU, the conditional MPDU error rate metric may comprise a probability distribution computed from the loss pattern as an empirical measure of the probability of a reception failure for another MPDU, spaced apart in time by a particular (temporal) distance from the given failure position. The probability may represent a statistical average over all such failure positions and relative (temporal) distances in the loss pattern. That is, the conditional probability distribution may be computed over a range of time offsets between MPDUs that spans the time window of interest.

As an illustrative but non-limiting example, such a conditional probability distribution may be expressed mathematically in terms of the probability, Pₑ, associated with an MPDU at index k relative to the i-th MPDU in the loss pattern as follows:

P_{c}(k)=Prob(i+k-th MPDU is in error|1-th MPDU is in error), Eq. (1)

where k is an integer spanning the time window of interest (e.g., −50<k<50 when looking up to 50 MPDUs in the future and past). It will be appreciated, however, that other statistical methods for auto-correlating the loss pattern values over time (e.g., as a function of the time lag between them) may be used in an equivalent manner to generate the conditional MPDU error rate metric, in accordance with various signal processing techniques and so on.

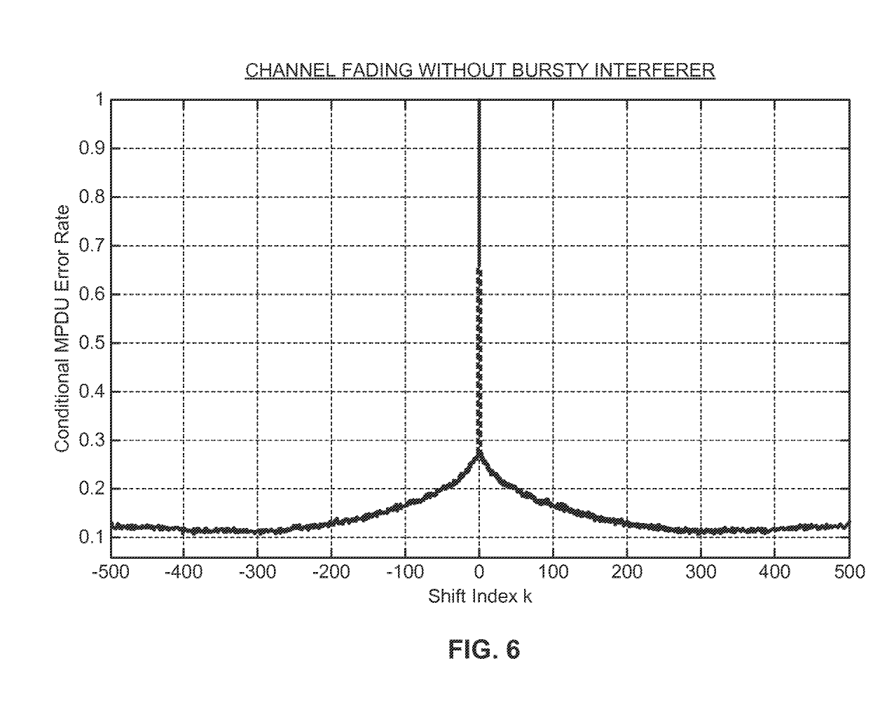

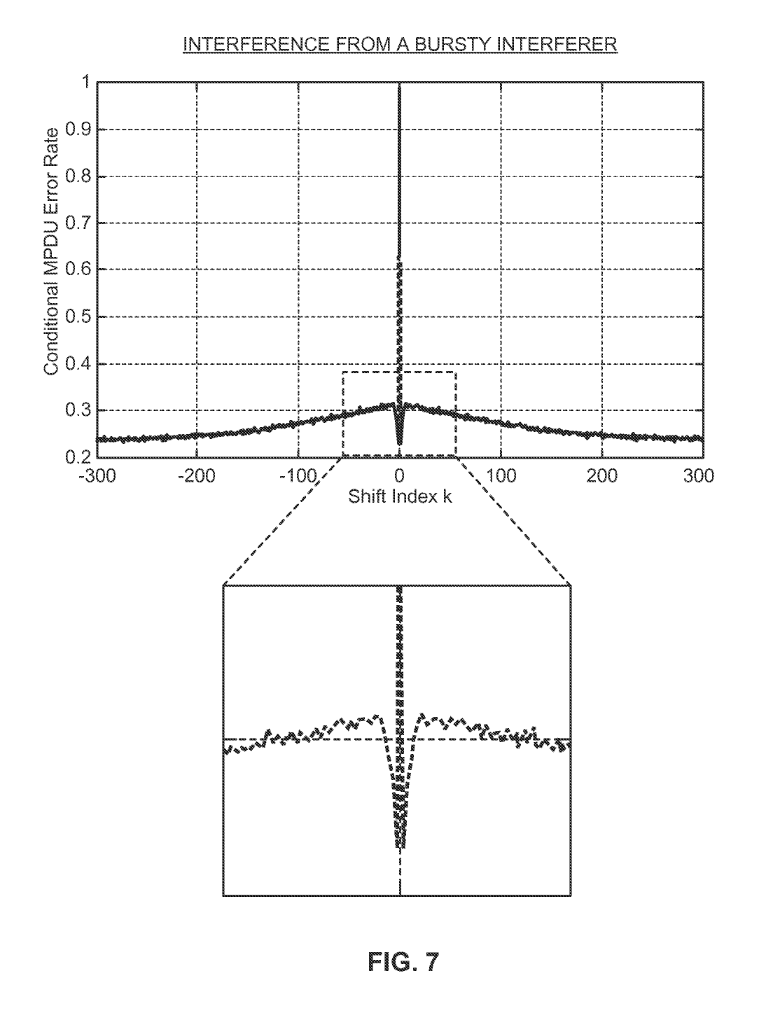

The conditional MPDU error rate metric analyzer 526 is configured to compare the conditional MPDU error rate metric to a corresponding bursty interference signature associated with a time-independence among the loss pattern values that is characteristic of bursty interference. The particular bursty interference signature employed will depend on the corresponding conditional MPDU error rate metric. Several examples are described below with reference to FIGS. 6-7.

FIG. 6 is an example probability distribution that is characteristic of channel fading without bursty interference. In this example, the probability distribution is taken over an index of −500<k<500 around a reference point at index k=0 representing a given MPDU failure. As shown, the distribution generally decreases in monotonic fashion with distance from the index k=0. This may be attributed to the fact that MPDUs closer to a given MPDU failure caused by channel fading conditions are more likely to experience the same fading. Meanwhile, the channel fading effects may dissipate for MPDUs that are farther away.

FIG. 7 is an example probability distribution that is characteristic of the presence of a bursty interferer. In this example, the probability distribution is taken over an index of −300<k<300 around a reference point at index k=0 representing a given MPDU failure. As shown, in contrast to the channel fading conditions of FIG. 6, the distribution here exhibits a sharp decrease in the probability values near the index k=0, before rising and returning to a generally monotonic decrease with distance. This characteristic dip in probability values near the index k=0 of the distribution may be attributed to the short-term (time-selective) nature of bursty interference where the interference is isolated to one (or potentially a small number) of MPDUs as discussed in more detail above. Accordingly, such a characteristic dip may be used in various ways as, or to otherwise derive, a corresponding bursty interference signature.

The bursty interference signature may comprise, for example, a similar conditional probability distribution representing the probability that would be observed, given that a reception failure has occurred for one MPDU, of a reception failure for another MPDU offset in time from the failed MPDU under bursty interference conditions. For example, this conditional probability distribution may exhibit a non-monotonic relationship over a range of time offsets in the vicinity of the given MPDU failure. In particular, the range of time offsets may include (i) a first sub-range closer to the given MPDU failure that comprises a decrease in the conditional probability and (ii) a second sub-range farther from the given MPDU failure that comprises an increase in the conditional probability.

Returning to FIG. 5, in response to the identification of a bursty interference condition on the communication channel by the bursty interference detector 420, the bursty interference controller 430 may generate a bursty interference indicator, which may take different forms in different designs and applications, ranging for example from a flag identifying the presence of bursty interference to more sophisticated control signaling.

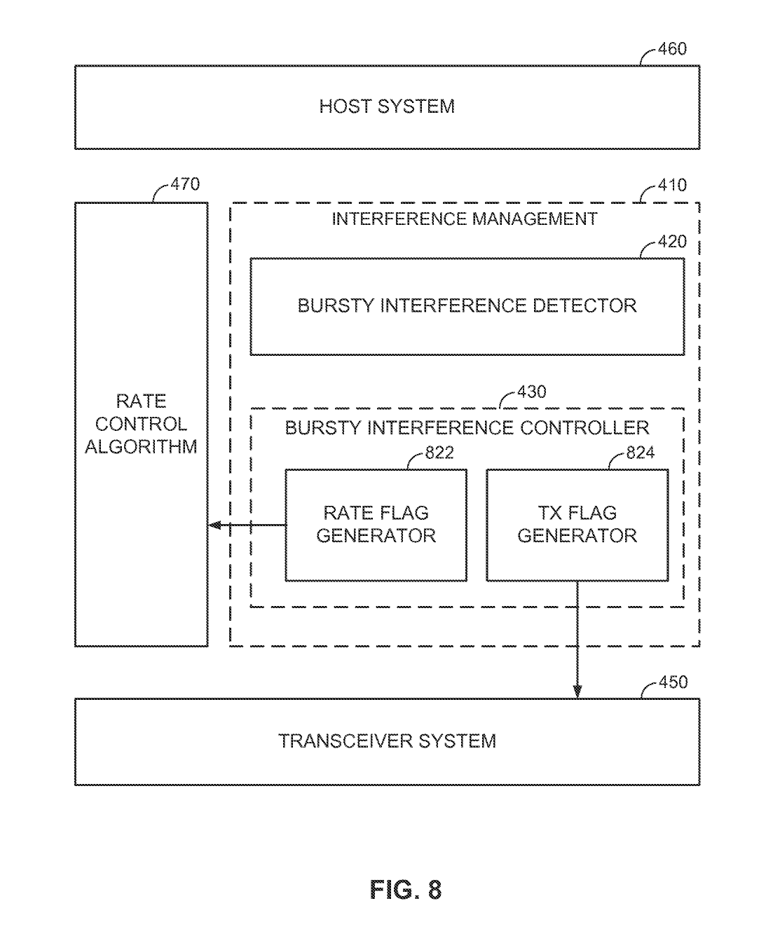

FIG. 8 is a block diagram illustrating an example design for one or more bursty interference control aspects of a bursty-interference-aware interference management module. In this example, the bursty interference controller 430 includes one or more bursty interference flag generators, two of which are shown for illustration purposes, including a rate flag generator 822 and a transmit (TX) flag generator 824.

The rate flag generator 822 is configured to output a bursty interference indicator to the rate control algorithm 470. This type of indicator allows the rate control algorithm 470 to react to channel fading interference and packet collision interference without confusing them with bursty interference. For example, the rate control algorithm 470 may maintain the currently selected rate (e.g., for a predetermined duration) or in some cases increase the currently selected rate in response to a sudden increase in packet error rate (PER) when the increase is identified as corresponding to bursty interference. Maintaining the currently selected rate even when PER increases suddenly prevents the short interference burst from affecting a larger proportion of packets as would be the case at lower rates, and keeps throughput from dropping further.

The TX flag generator 824 is configured to output a bursty interference indicator to the transceiver system 450. This type of indicator allows the transceiver system 450 to schedule transmissions around any perceived bursty interference. For example, the transceiver system 450 may identify a corresponding duty cycle of a jammer entity associated with the bursty interference, and schedule data transmissions at other times.

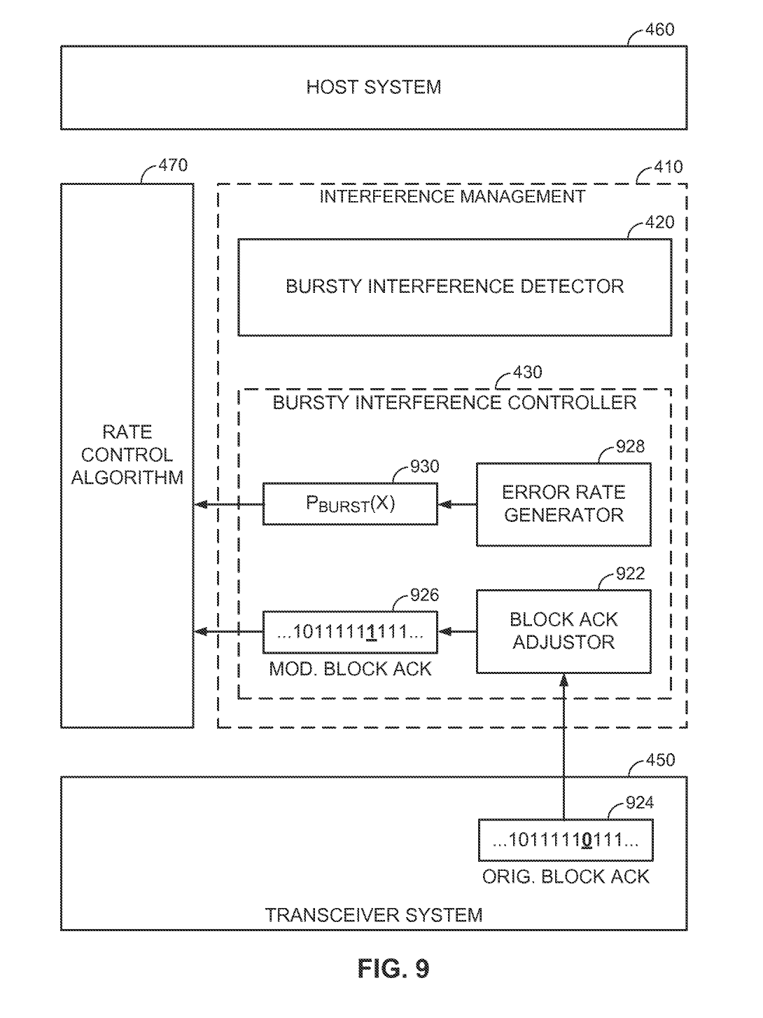

FIG. 9 is a block diagram illustrating another example design for one or more bursty interference control aspects of a bursty-interference-aware interference management module. In this example, the bursty interference controller 430 includes one or more rate control metric adjustors, two of which are shown for illustration purposes, including a block ACK adjustor 922 and an error rate generator 928.

The block ACK adjustor 922 is configured to output a modified block ACK to the rate control algorithm 470. As discussed above, aggregation and acknowledgment via a block ACK may improve throughput and efficiency, but ordinary block ACKs do not distinguish between different types of interference. Accordingly, as with the rate flag indicator of FIG. 8, by modifying an original block ACK to, for example, exclude short burst errors, the rate control algorithm 470 may be controlled to react to channel fading interference and packet collision interference without confusing them with bursty interference. In the illustrated example, the block ACK adjustor 922 receives an original block ACK 924 (e.g., from the transceiver system 450), identifies any errors that may be due to short interference bursts (one such error is shown for illustration purposes), and scrubs those errors before passing a modified block ACK 926 to the rate control algorithm 470.

The error rate generator 928 is configured to collect bursty error rate statistics and output a bursty error rate probability metric P_{burst}(X) 930 to the rate control algorithm 470. The bursty error rate probability metric P_{burst}(X) 930 provides a measure of MPDU losses due to short bursts of interference, in a manner similar to the non-bursty error rate probability metrics upon which conventional throughput calculations of the rate control algorithm 470 are based. By providing a separate error rate term for bursty interference as distinct from non-bursty (e.g., channel fading and packet collision) interference, a modified throughput formula may be used to more accurately capture the distinct effects of the different categories of interference, which, as discussed above, affect rate selection in different ways.

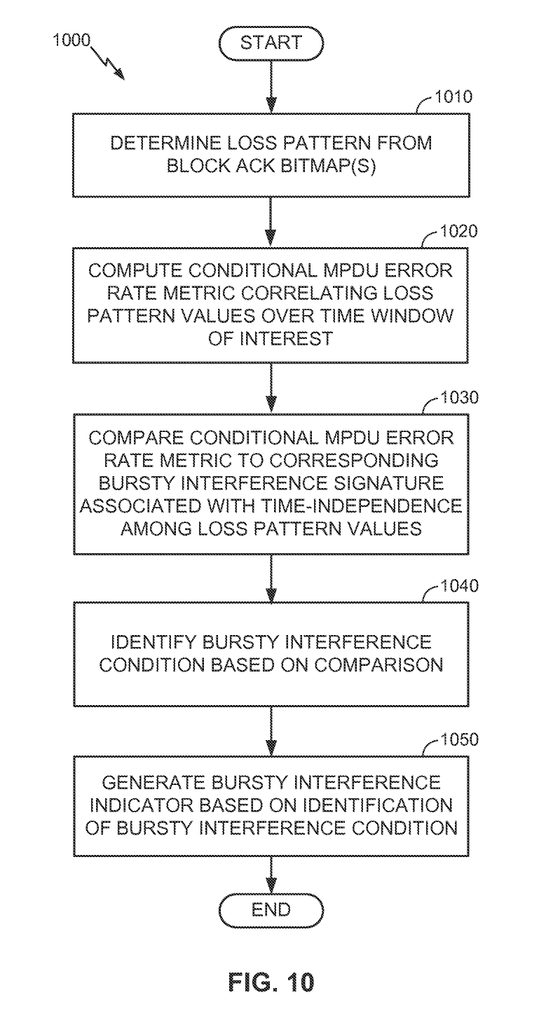

FIG. 10 is a flow diagram illustrating an example method of interference management for a wireless device in a wireless communication system. The method may be performed by a Wi-Fi access point, for example, such as the AP 110 in FIG. 1, or more generally any entity performing or assisting with rate control (e.g., one of the STAs 120 in FIG. 1). In this example, the method 1000 includes determining a loss pattern from one or more block ACK bitmaps (block 1010). The loss pattern may comprise a plurality of values indicating reception success or reception failure of a corresponding MPDU at a receiving station (e.g., one of the STAs 120 in FIG. 1). A conditional MPDU error rate metric may then be computed correlating the loss pattern values over a time window of interest (block 1020). The conditional MPDU error rate metric may be compared to a corresponding bursty interference signature associated with a time-independence among the loss pattern values that is characteristic of bursty interference (block 1030). Based on the comparison, a bursty interference condition may be identified (block 1040) and a bursty interference indicator may be generated (block 1050).

As discussed in more detail above, the conditional MPDU error rate metric may comprise, for example, a conditional probability distribution computed from the loss pattern as an empirical measure of the probability, given that a reception failure has occurred for a first MPDU, of a reception failure for a second MPDU offset in time from the first MPDU. The conditional probability distribution may be computed over a range of time offsets between the first and second MPDUs that spans the time window of interest. For example, the conditional probability distribution may be computed as the probability that the i+k-th MPDU is in error given that the i-th MPDU is in error, where i corresponds to the position in the loss pattern of the first MPDU and where k is an index corresponding to the position in the loss pattern of the second MPDU relative to the first MPDU (e.g., −N≦k≦N, with [−N, N] being the range of time offsets that spans the time window of interest).

Similarly, the bursty interference signature may comprise, for example, a conditional probability distribution representing the probability, given that a reception failure has occurred for a first MPDU, of a reception failure for a second MPDU offset in time from the first MPDU. This conditional probability distribution may exhibit a non-monotonic relationship over a range of time offsets between the first and second MPDUs in the vicinity of the first MPDU. More specifically, the range of time offsets may include (i) a first sub-range closer to the first MPDU that comprises a decrease in the conditional probability and (ii) a second sub-range farther from the first MPDU that comprises an increase in the conditional probability.

In some designs, the determining (block 1010) may comprise aggregating information from multiple block ACK bitmaps among the one or more block ACK bitmaps over the time window of interest. The time window of interest may be a sliding time window and the aggregating may be performed repeatedly at successive locations of the sliding time window. The determining (block 1010) may comprise pre-processing the one or more block ACK bitmaps to remove any ACK bits corresponding to MPDUs that were not re-transmitted.

In some designs, the one or more block ACK bitmaps may be received by an access point (e.g., the AP 110 in FIG. 1) from a subscriber station (e.g., one of the STAs 120 in FIG. 1), with the access point performing the determining (block 1010), the computing (block 1020), and the comparing (block 1030). Alternatively, the one or more block ACK bitmaps may generated by a subscriber station (e.g., one of the STAs 120 in FIG. 1), with the subscriber station performing the determining (block 1010), the computing (block 1020), and the comparing (block 1030).

As further discussed in more detail above, the generating (block 1050) may comprise generating a flag for a rate control algorithm operating at the wireless device. Alternatively or in addition, the generating (block 1050) may comprise modifying at least one bit of a block ACK bitmap based on the identification of the bursty interference condition.

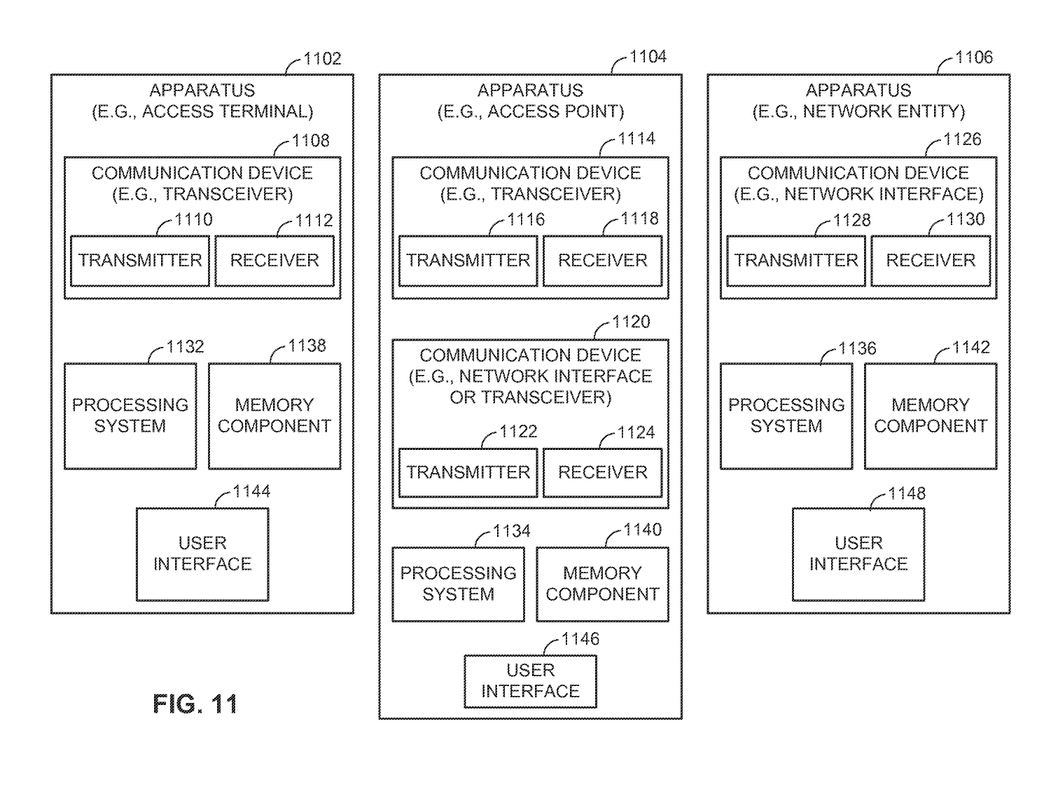

FIG. 11 illustrates several sample components (represented by corresponding blocks) that may be incorporated into an apparatus 1102, an apparatus 1104, and an apparatus 1106 (e.g., corresponding to an access terminal, an access point, and a network entity, respectively) to support interference management operations as taught herein. It should be appreciated that these components may be implemented in different types of apparatuses in different implementations (e.g., in an ASIC, in an SoC, etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 1102 and the apparatus 1104 each include at least one wireless communication device (represented by the communication devices 1108 and 1114 (and the communication device 1120 if the apparatus 1104 is a relay)) for communicating with other nodes via at least one designated radio access technology. Each communication device 1108 includes at least one transmitter (represented by the transmitter 1110) for transmitting and encoding signals (e.g., messages, indications, information, and so on) and at least one receiver (represented by the receiver 1112) for receiving and decoding signals (e.g., messages, indications, information, pilots, and so on). Similarly, each communication device 1114 includes at least one transmitter (represented by the transmitter 1116) for transmitting signals (e.g., messages, indications, information, pilots, and so on) and at least one receiver (represented by the receiver 1118) for receiving signals (e.g., messages, indications, information, and so on). If the apparatus 1104 is a relay access point, each communication device 1120 may include at least one transmitter (represented by the transmitter 1122) for transmitting signals (e.g., messages, indications, information, pilots, and so on) and at least one receiver (represented by the receiver 1124) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 1104 comprises a network listen module.

The apparatus 1106 (and the apparatus 1104 if it is not a relay access point) includes at least one communication device (represented by the communication device 1126 and, optionally, 1120) for communicating with other nodes. For example, the communication device 1126 may comprise a network interface that is configured to communicate with one or more network entities via a wire-based or wireless backhaul. In some aspects, the communication device 1126 may be implemented as a transceiver configured to support wire-based or wireless signal communication. This communication may involve, for example, sending and receiving: messages, parameters, or other types of information. Accordingly, in the example of FIG. 11, the communication device 1126 is shown as comprising a transmitter 1128 and a receiver 1130. Similarly, if the apparatus 1104 is not a relay access point, the communication device 1120 may comprise a network interface that is configured to communicate with one or more network entities via a wire-based or wireless backhaul. As with the communication device 1126, the communication device 1120 is shown as comprising a transmitter 1122 and a receiver 1124.

The apparatuses 1102, 1104, and 1106 also include other components that may be used in conjunction with interference management operations as taught herein. The apparatus 1102 includes a processing system 1132 for providing functionality relating to, for example, communicating with an access point to support interference management as taught herein and for providing other processing functionality. The apparatus 1104 includes a processing system 1134 for providing functionality relating to, for example, interference management as taught herein and for providing other processing functionality. The apparatus 1106 includes a processing system 1136 for providing functionality relating to, for example, interference management as taught herein and for providing other processing functionality. The apparatuses 1102, 1104, and 1106 include memory devices 1138, 1140, and 1142 (e.g., each including a memory device), respectively, for maintaining information (e.g., information indicative of reserved resources, thresholds, parameters, and so on). In addition, the apparatuses 1102, 1104, and 1106 include user interface devices 1144, 1146, and 1148, respectively, for providing indications (e.g., audible and/or visual indications) to a user and/or for receiving user input (e.g., upon user actuation of a sensing device such a keypad, a touch screen, a microphone, and so on).

For convenience, the apparatus 1102 is shown in FIG. 11 as including components that may be used in the various examples described herein. In practice, the illustrated blocks may have different functionality in different aspects.

The components of FIG. 11 may be implemented in various ways. In some implementations, the components of FIG. 11 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1108, 1132, 1138, and 1144 may be implemented by processor and memory component(s) of the apparatus 1102 (e.g., by execution of appropriate code and/or by appropriate configuration of processor components). Similarly, some or all of the functionality represented by blocks 1114, 1120, 1134, 1140, and 1146 may be implemented by processor and memory component(s) of the apparatus 1104 (e.g., by execution of appropriate code and/or by appropriate configuration of processor components). Also, some or all of the functionality represented by blocks 1126, 1136, 1142, and 1148 may be implemented by processor and memory component(s) of the apparatus 1106 (e.g., by execution of appropriate code and/or by appropriate configuration of processor components).

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into Nₛ independent channels, which are also referred to as spatial channels, where Nₛ<min {N_{T}, N_{R}}. Each of the Nₛ independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

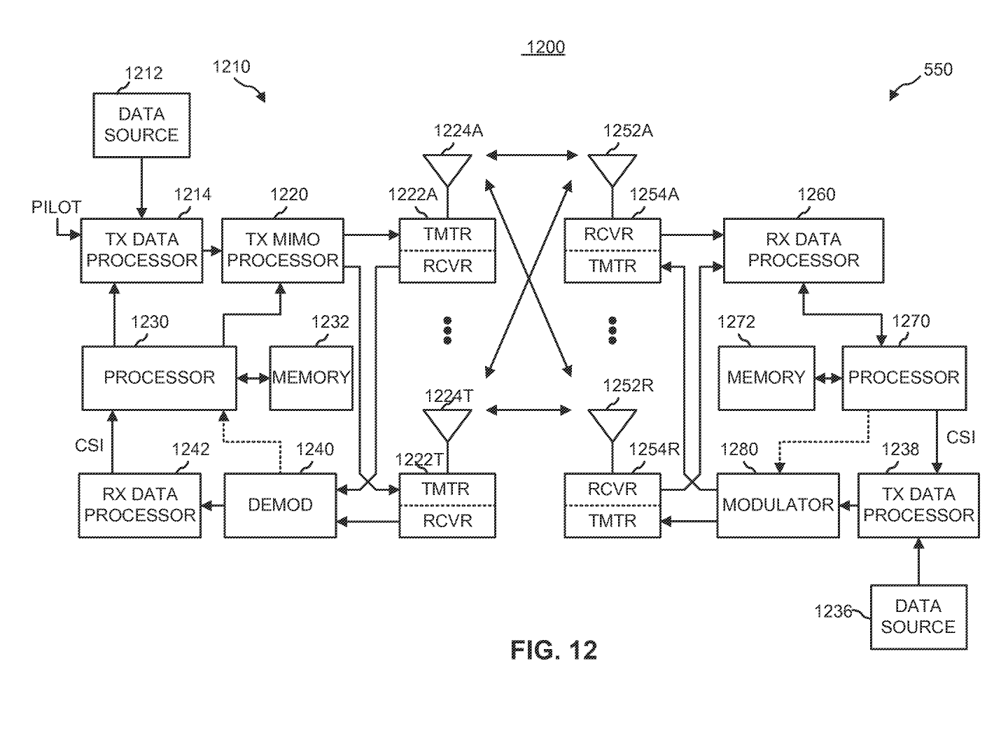

FIG. 12 illustrates in more detail the components of a wireless device 1210 (e.g., an AP) and a wireless device 1250 (e.g., an STA) of a sample communication system 1200 that may be adapted as described herein. At the device 1210, traffic data for a number of data streams is provided from a data source 1212 to a transmit (TX) data processor 1214. Each data stream may then be transmitted over a respective transmit antenna.

The TX data processor 1214 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1230. A data memory 1232 may store program code, data, and other information used by the processor 1230 or other components of the device 1210.

The modulation symbols for all data streams are then provided to a TX MIMO processor 1220, which may further process the modulation symbols (e.g., for OFDM). The TX MIMO processor 1220 then provides NT modulation symbol streams to NT transceivers (XCVR) 1222A through 1222T. In some aspects, the TX MIMO processor 1220 applies beam-forming weights to the symbols of the data streams and to the antenna from which the symbol is being transmitted.

Each transceiver 1222 receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 1222A through 1222T are then transmitted from NT antennas 1224A through 1224T, respectively.

At the device 1250, the transmitted modulated signals are received by NR antennas 1252A through 1252R and the received signal from each antenna 1252 is provided to a respective transceiver (XCVR) 1254A through 1254R. Each transceiver 1254 conditions (e.g., filters, amplifies, and downconverts) a respective received signal, digitizes the conditioned signal to provide samples, and further processes the samples to provide a corresponding “received” symbol stream.

A receive (RX) data processor 1260 then receives and processes the NR received symbol streams from NR transceivers 1254 based on a particular receiver processing technique to provide NT “detected” symbol streams. The RX data processor 1260 then demodulates, deinterleaves, and decodes each detected symbol stream to recover the traffic data for the data stream. The processing by the RX data processor 1260 is complementary to that performed by the TX MIMO processor 1220 and the TX data processor 1214 at the device 1210.

A processor 1270 periodically determines which pre-coding matrix to use (discussed below). The processor 1270 formulates a reverse link message comprising a matrix index portion and a rank value portion. A data memory 1272 may store program code, data, and other information used by the processor 1270 or other components of the device 1250.

The reverse link message may comprise various types of information regarding the communication link and/or the received data stream. The reverse link message is then processed by a TX data processor 1238, which also receives traffic data for a number of data streams from a data source 1236, modulated by a modulator 1280, conditioned by the transceivers 1254A through 1254R, and transmitted back to the device 1210.

At the device 1210, the modulated signals from the device 1250 are received by the antennas 1224, conditioned by the transceivers 1222, demodulated by a demodulator (DEMOD) 1240, and processed by a RX data processor 1242 to extract the reverse link message transmitted by the device 1250. The processor 1230 then determines which pre-coding matrix to use for determining the beam-forming weights then processes the extracted message.

It will be appreciated that for each device 1210 and 1250 the functionality of two or more of the described components may be provided by a single component. It will be also be appreciated that the various communication components illustrated in FIG. 12 and described above may be further configured as appropriate to perform interference management as taught herein. For example, the processors 1230/1270 may cooperate with the memories 1232/1272 and/or other components of the respective devices 1210/1250 to perform the interference management as taught herein.

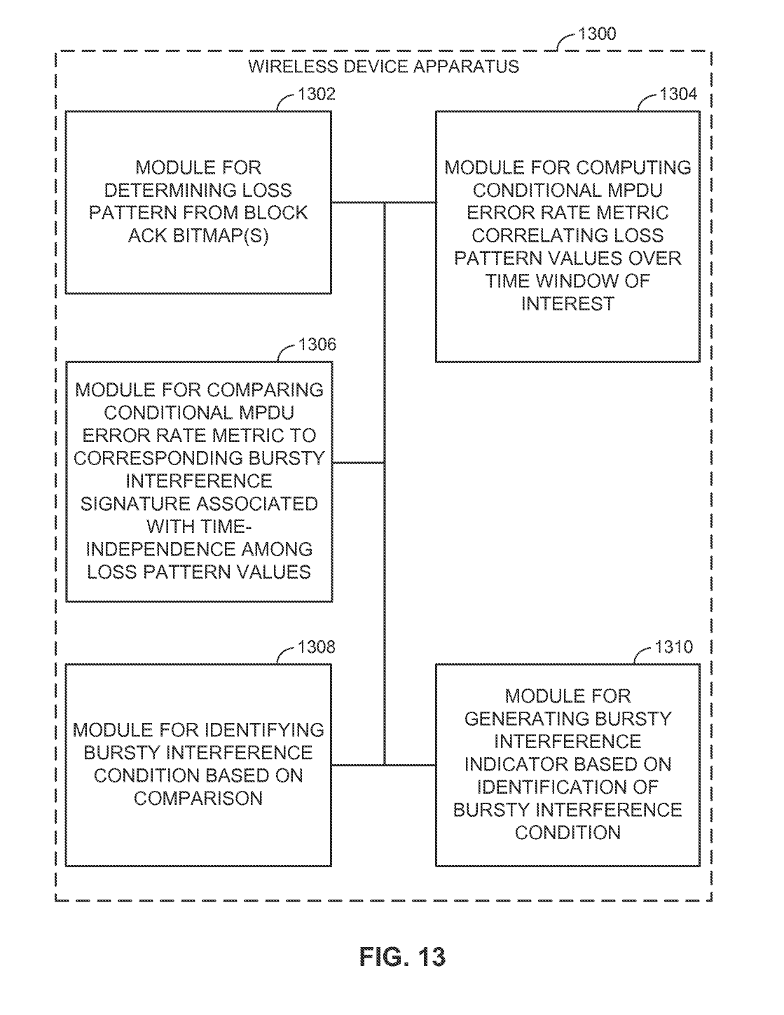

FIG. 13 illustrates an example (e.g., access point) apparatus 1300 represented as a series of interrelated functional modules. A module for determining 1302 may correspond at least in some aspects to, for example, a processing system as discussed herein. A module for computing 1304 may correspond at least in some aspects to, for example, a processing system as discussed herein. A module for comparing 1306 may correspond at least in some aspects to, for example, a processing system as discussed herein. A module for identifying 1308 may correspond at least in some aspects to, for example, a processing system as discussed herein. A module for generating 1310 may correspond at least in some aspects to, for example, a processing system as discussed herein.

The functionality of the modules of FIG. 13 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module.

In addition, the components and functions represented by FIG. 13 as well as other components and functions described herein, may be implemented using any suitable means. Such means also may be implemented, at least in part, using corresponding structure as taught herein. For example, the components described above in conjunction with the “module for” components of FIG. 13 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for interference management for a wireless device in a wireless communication system. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of interference management for a wireless device in a wireless communication system, comprising:
determining a loss pattern from one or more block acknowledgement (ACK) bitmaps, the loss pattern comprising a plurality of values indicating reception success or reception failure of a corresponding media access control (MAC) protocol data unit (MPDU) at a receiving station;
computing a conditional MPDU error rate metric correlating the loss pattern values over a time window of interest;
comparing the conditional MPDU error rate metric to a corresponding bursty interference signature associated with a time-independence among the loss pattern values that is characteristic of bursty interference;
identifying a bursty interference condition based on the comparison; and
generating a bursty interference indicator based on the identification of the bursty interference condition.

2. The method of claim 1, wherein the conditional MPDU error rate metric comprises a conditional probability distribution computed from the loss pattern as an empirical measure of the probability, given that a reception failure has occurred for a first MPDU, of a reception failure for a second MPDU offset in time from the first MPDU.

3. The method of claim 2, wherein the conditional probability distribution is computed over a range of time offsets between the first and second MPDUs that spans the time window of interest.

4. The method of claim 3, wherein the conditional probability distribution (Pₐ) is computed as follows:
P_{c}(k)=Prob(i+k-th MPDU is in error|i-th MPDU is in error),
where i corresponds to the position in the loss pattern of the first MPDU, and where k is an index corresponding to the position in the loss pattern of the second MPDU relative to the first MPDU, with −N≦k≦N and [−N, N] being the range of time offsets that spans the time window of interest.

5. The method of claim 1, wherein the bursty interference signature comprises a conditional probability distribution representing the probability, given that a reception failure has occurred for a first MPDU, of a reception failure for a second MPDU offset in time from the first MPDU.

6. The method of claim 5, wherein the conditional probability distribution exhibits a non-monotonic relationship over a range of time offsets between the first and second MPDUs in the vicinity of the first MPDU.

7. The method of claim 6, wherein the range of time offsets includes (i) a first sub-range closer to the first MPDU that comprises a decrease in the conditional probability and (ii) a second sub-range farther from the first MPDU that comprises an increase in the conditional probability.

8. The method of claim 1, wherein the determining comprises aggregating information from multiple block ACK bitmaps among the one or more block ACK bitmaps over the time window of interest.

9. The method of claim 8, wherein the time window of interest is a sliding time window and the aggregating is performed repeatedly at successive locations of the sliding time window.

10. The method of claim 1, wherein the one or more block ACK bitmaps are received by an access point from a subscriber station, the access point performing the determining, computing, and comparing.

11. The method of claim 1, wherein the one or more block ACK bitmaps are generated by a subscriber station, the subscriber station performing the determining, computing, and comparing.

12. The method of claim 1, wherein the determining comprises pre-processing the one or more block ACK bitmaps to remove any ACK bits corresponding to MPDUs that were not re-transmitted.

13. The method of claim 1, wherein the generating comprises generating a flag for a rate control algorithm operating at the wireless device.

14. The method of claim 1, wherein the generating comprises modifying at least one bit of a block ACK bitmap based on the identification of the bursty interference condition.

15. An apparatus for interference management for a wireless device in a wireless communication system, comprising:
a processor configured to:
determine a loss pattern from one or more block acknowledgement (ACK) bitmaps, the loss pattern comprising a plurality of values indicating reception success or reception failure of a corresponding media access control (MAC) protocol data unit (MPDU) at a receiving station,
compute a conditional MPDU error rate metric correlating the loss pattern values over a time window of interest,
compare the conditional MPDU error rate metric to a corresponding bursty interference signature associated with a time-independence among the loss pattern values that is characteristic of bursty interference,
identify a bursty interference condition based on the comparison, and
generate a bursty interference indicator based on the identification of the bursty interference condition; and
memory coupled to the processor for storing related data and instructions.

16. The apparatus of claim 15, wherein the conditional MPDU error rate metric comprises a conditional probability distribution computed from the loss pattern as an empirical measure of the probability, given that a reception failure has occurred for a first MPDU, of a reception failure for a second MPDU offset in time from the first MPDU.

17. The apparatus of claim 16, wherein the conditional probability distribution is computed over a range of time offsets between the first and second MPDUs that spans the time window of interest.

18. The apparatus of claim 17, wherein the conditional probability distribution (Pₐ) is computed as follows:
P_{c}(k)=Prob(i+k-th MPDU is in error|i-th MPDU is in error),
where i corresponds to the position in the loss pattern of the first MPDU, and where k is an index corresponding to the position in the loss pattern of the second MPDU relative to the first MPDU, with −N≦k≦N and [−N, N] being the range of time offsets that spans the time window of interest.

19. The apparatus of claim 15, wherein the bursty interference signature comprises a conditional probability distribution representing the probability, given that a reception failure has occurred for a first MPDU, of a reception failure for a second MPDU offset in time from the first MPDU.

20. The apparatus of claim 19, wherein the conditional probability distribution exhibits a non-monotonic relationship over a range of time offsets between the first and second MPDUs in the vicinity of the first MPDU.

21. The apparatus of claim 20, wherein the range of time offsets includes (i) a first sub-range closer to the first MPDU that comprises a decrease in the conditional probability and (ii) a second sub-range farther from the first MPDU that comprises an increase in the conditional probability.

22. The apparatus of claim 15, wherein the determining comprises aggregating information from multiple block ACK bitmaps among the one or more block ACK bitmaps over the time window of interest.

23. The apparatus of claim 22, wherein the time window of interest is a sliding time window and the aggregating is performed repeatedly at successive locations of the sliding time window.

24. The apparatus of claim 15, wherein the wireless device corresponds to an access point, the apparatus further comprising a receiver configured to receive the one or more block ACK bitmaps at the access point from a subscriber station.

25. The apparatus of claim 15, wherein the wireless device corresponds to a subscriber station, the processor being further configured to generate the one or more block ACK bitmaps at the subscriber station.

26. The apparatus of claim 15, wherein the determining comprises pre-processing the one or more block ACK bitmaps to remove any ACK bits corresponding to MPDUs that were not re-transmitted.

27. The apparatus of claim 15, wherein the generating comprises generating a flag for a rate control algorithm operating at the wireless device.

28. The apparatus of claim 15, wherein the generating comprises modifying at least one bit of a block ACK bitmap based on the identification of the bursty interference condition.

29. An apparatus for interference management for a wireless device in a wireless communication system, comprising:
means for determining a loss pattern from one or more block acknowledgement (ACK) bitmaps, the loss pattern comprising a plurality of values indicating reception success or reception failure of a corresponding media access control (MAC) protocol data unit (MPDU) at a receiving station;
means for computing a conditional MPDU error rate metric correlating the loss pattern values over a time window of interest;
means for comparing the conditional MPDU error rate metric to a corresponding bursty interference signature associated with a time-independence among the loss pattern values that is characteristic of bursty interference;
means for identifying a bursty interference condition based on the comparison; and
means for generating a bursty interference indicator based on the identification of the bursty interference condition.

30. The apparatus of claim 29, wherein the conditional MPDU error rate metric comprises a conditional probability distribution computed from the loss pattern as an empirical measure of the probability, given that a reception failure has occurred for a first MPDU, of a reception failure for a second MPDU offset in time from the first MPDU.

31. The apparatus of claim 30, wherein the conditional probability distribution is computed over a range of time offsets between the first and second MPDUs that spans the time window of interest.

32. The apparatus of claim 31, wherein the conditional probability distribution (Pₐ) is computed as follows:
P_{c}(k)=Prob(i+k-th MPDU is in error|i-th MPDU is in error),
where i corresponds to the position in the loss pattern of the first MPDU, and where k is an index corresponding to the position in the loss pattern of the second MPDU relative to the first MPDU, with −N≦k≦N and [−N, N] being the range of time offsets that spans the time window of interest.

33. The apparatus of claim 29, wherein the bursty interference signature comprises a conditional probability distribution representing the probability, given that a reception failure has occurred for a first MPDU, of a reception failure for a second MPDU offset in time from the first MPDU.

34. The apparatus of claim 33, wherein the conditional probability distribution exhibits a non-monotonic relationship over a range of time offsets between the first and second MPDUs in the vicinity of the first MPDU.

35. The apparatus of claim 34, wherein the range of time offsets includes (i) a first sub-range closer to the first MPDU that comprises a decrease in the conditional probability and (ii) a second sub-range farther from the first MPDU that comprises an increase in the conditional probability.

36. The apparatus of claim 29, wherein the means for determining comprises means for aggregating information from multiple block ACK bitmaps among the one or more block ACK bitmaps over the time window of interest.

37. The apparatus of claim 36, wherein the time window of interest is a sliding time window and the means for aggregating operates repeatedly at successive locations of the sliding time window.

38. The apparatus of claim 29, wherein the wireless device corresponds to an access point, the apparatus further comprising means for receiving the one or more block ACK bitmaps at the access point from a subscriber station.

39. The apparatus of claim 29, wherein the wireless device corresponds to a subscriber station, the apparatus further comprising means for generating the one or more block ACK bitmaps at the subscriber station.

40. The apparatus of claim 29, wherein the means for determining comprises means for pre-processing the one or more block ACK bitmaps to remove any ACK bits corresponding to MPDUs that were not re-transmitted.

41. The apparatus of claim 29, wherein the means for generating comprises means for generating a flag for a rate control algorithm operating at the wireless device.

42. The apparatus of claim 29, wherein the means for generating comprises means for modifying at least one bit of a block ACK bitmap based on the identification of the bursty interference condition.

43. A non-transitory computer-readable medium comprising code, which, when executed by a processor, causes the processor to perform operations for interference management for a wireless device in a wireless communication system, the non-transitory computer-readable medium comprising:
code for determining a loss pattern from one or more block acknowledgement (ACK) bitmaps, the loss pattern comprising a plurality of values indicating reception success or reception failure of a corresponding media access control (MAC) protocol data unit (MPDU) at a receiving station;
code for computing a conditional MPDU error rate metric correlating the loss pattern values over a time window of interest;
code for comparing the conditional MPDU error rate metric to a corresponding bursty interference signature associated with a time-independence among the loss pattern values that is characteristic of bursty interference;
code for identifying a bursty interference condition based on the comparison; and
code for generating a bursty interference indicator based on the identification of the bursty interference condition.

44. The non-transitory computer-readable medium of claim 43, wherein the conditional MPDU error rate metric comprises a conditional probability distribution computed from the loss pattern as an empirical measure of the probability, given that a reception failure has occurred for a first MPDU, of a reception failure for a second MPDU offset in time from the first MPDU.

45. The non-transitory computer-readable medium of claim 44, wherein the conditional probability distribution is computed over a range of time offsets between the first and second MPDUs that spans the time window of interest.

46. The non-transitory computer-readable medium of claim 45, wherein the conditional probability distribution (Pₐ) is computed as follows:
P_{c}(k)=Prob(i+k-th MPDU is in error|i-th MPDU is in error),
where i corresponds to the position in the loss pattern of the first MPDU, and where k is an index corresponding to the position in the loss pattern of the second MPDU relative to the first MPDU, with −N≦k≦N and [−N, N] being the range of time offsets that spans the time window of interest.

47. The non-transitory computer-readable medium of claim 43, wherein the bursty interference signature comprises a conditional probability distribution representing the probability, given that a reception failure has occurred for a first MPDU, of a reception failure for a second MPDU offset in time from the first MPDU.

48. The non-transitory computer-readable medium of claim 47, wherein the conditional probability distribution exhibits a non-monotonic relationship over a range of time offsets between the first and second MPDUs in the vicinity of the first MPDU.

49. The non-transitory computer-readable medium of claim 48, wherein the range of time offsets includes (i) a first sub-range closer to the first MPDU that comprises a decrease in the conditional probability and (ii) a second sub-range farther from the first MPDU that comprises an increase in the conditional probability.

50. The non-transitory computer-readable medium of claim 43, wherein the code for determining comprises code for aggregating information from multiple block ACK bitmaps among the one or more block ACK bitmaps over the time window of interest.

51. The non-transitory computer-readable medium of claim 50, wherein the time window of interest is a sliding time window and the code for aggregating operates repeatedly at successive locations of the sliding time window.

52. The non-transitory computer-readable medium of claim 43, wherein the wireless device corresponds to an access point, the non-transitory computer-readable medium further comprising code for receiving the one or more block ACK bitmaps at the access point from a subscriber station.

53. The non-transitory computer-readable medium of claim 43, wherein the wireless device corresponds to a subscriber station, the non-transitory computer-readable medium further comprising code for generating the one or more block ACK bitmaps at the subscriber station.

54. The non-transitory computer-readable medium of claim 43, wherein the code for determining comprises code for pre-processing the one or more block ACK bitmaps to remove any ACK bits corresponding to MPDUs that were not re-transmitted.

55. The non-transitory computer-readable medium of claim 43, wherein the code for generating comprises code for generating a flag for a rate control algorithm operating at the wireless device.

56. The non-transitory computer-readable medium of claim 43, wherein the code for generating comprises code for modifying at least one bit of a block ACK bitmap based on the identification of the bursty interference condition.
